(19) United States
(12) Patent Application Publication
(10) Pub. No.: US 2016/0010368 A1
(43) Pub. Date: Jan. 14, 2016

(54) STRUCTURE FOR ATTACHING VEHICLE DOOR HANDLE DEVICE

(71) Applicant: HONDA MOTOR CO., LTD., Minato-ku, Tokyo (JP)

(72) Inventors: Kenichi Tanoguchi, Wako-shi (JP); Eiji Hirano, Wako-shi (JP); Katsuya Ashizawa, Hagagun (JP)

(73) Assignee: HONDA MOTOR CO., LTD., Tokyo (JP)

(21) Appl. No.: 14/763,567

(22) PCT Filed: Nov. 13, 2013
(86) PCT No.: PCT/JP2013/080681

§ 371 Date: Jul. 27, 2015

(30) Foreign Application Priority Data
Feb. 6, 2013 (JP) 2013-021778

(51) Int. Cl. E05B 85/12; E05B 79/06; B60J 5/04

(52) U.S. Cl. CPC E05B 85/12; B60J 5/0493; E05B 79/06

(57) ABSTRACT

A vehicle door handle device (20) is attached to a door panel of a vehicle door and a lining covering the cabin-interior side of the door panel. The vehicle door handle device (20) has a swing shaft (41) extending to the top and bottom of a base member (30), and a swingable handle part (42) attached to the swing shaft (41). Formed in the peripheral edge of the base member (30) are a panel attachment part (31-33) attached to the door panel (11), and a lining attachment part (34-36) attached to the lining (12). The panel attachment part (31-33) is configured to be capable of moving relative to the door panel (11) within a predetermined range, and the lining attachment part (34-36) is attached to the lining (12) via an elastic clip (74). The clip (74) urges the base member (30) toward the lining (12).

### TECHNICAL FIELD

The present invention relates to an attaching or mounting structure for a vehicle door handle device that is to be mounted to both a door panel and a lining for an operation to open and close the vehicle door.

### BACKGROUND ART

In many vehicles, a vehicle door handle device is attached or mounted to an inner side of a door facing a passenger compartment. An example of a structure for mounting such a vehicle door handle device (i.e., a mounting structure for vehicle door handle device) is disclosed in Patent Literature 1.

The vehicle door handle device disclosed in Patent Literature 1 is fixed by a base member as a body of the vehicle door handle device being sandwiched between a door panel and a lining and by these door panel and lining being joined together by means of bolts and nuts.

To mount such a vehicle door handle device, first of all, the base member is accurately positioned relative to a mounting section of the door panel. With the base member accurately positioned like this, the lining is superimposed on the base member, and then the door panel and the lining are joined together. Respective mounting sections of the lining and the door panel must be positioned in alignment with each other with attention such that the base member is not inadvertently dropped. Thus, the vehicle door handle device disclosed in Patent Literature 1 has a room for further improvement in terms of its mountability.

### PRIOR ART LITERATURE

### Patent Literature

Patent Literature 1: Japanese Patent Application Laid-Open Publication No. 2010-36682.

### SUMMARY OF INVENTION

### Technical Problem

It is therefore an object of the present invention to provide an improved technique which allows a vehicle door handle device to be mounted with ease.

### Solution to Problem

According to the present invention, there is provided a mounting structure for a vehicle door handle device comprising a door panel of the vehicle door, a lining covering an inner side of the door panel facing a passenger compartment, and a vehicle door handle device mounted to both the door panel and the lining and operable to open and close the door, the vehicle door handle device including a pivot shaft mounted to extend vertically toward upper and lower wall portions of a base member and a handle section pivotably mounted on the pivot shaft, the base member including mounted-to-panel sections and mounted-to-lining sections formed on a peripheral edge thereof, the mounted-to-panel sections being mounted to the door panel, the mounted-to-lining sections being mounted to the lining, the mounted-to-panel sections being each constructed to be movable within a predetermined range relative to the door panel, the mounted-to-lining sections being mounted to the lining by means of resilient clips, the clips normally biasing the base member toward the lining.

Preferably, in the mounting structure of the invention, at least one of the mounted-to-panel sections is disposed on a side toward which the handle section is pivotally pulled relative to the pivot shaft.

Preferably, the mounted-to-panel sections are provided in a pair on upper and lower portions of the peripheral edge of the base member, and an imaginary line interconnecting the pair of the mounted-to-panel sections intersects an axis line of the pivot shaft in a front-rear direction of the vehicle body.

Preferably, the mounted-to-lining sections are provided in a pair on upper and lower portions of the peripheral edge of the base member, an imaginary line interconnecting the mounted-to-lining sections not only tilts in an opposite oblique front-rear direction from the imaginary line interconnecting the pair of the mounted-to-panel sections but also interests the axis line of the pivot shaft, and the imaginary line interconnecting the pair of the mounted-to-panel sections and the imaginary line interconnecting the mounted-to-lining sections intersect each other.

Preferably, one of the pair of the mounted-to-lining sections is mounted to the lining by means of one of the clips that is vertically resiliently deformable, and the other of the pair of the mounted-to-lining sections is mounted to the lining by means of another of the clips that is horizontally resiliently deformable.

Preferably, each of the mounted-to-panel sections is mounted to the door panel by means of a stepped bolt, and a gap between a panel mounting hole formed in the mounted-to-panel section and having the stepped bolt inserted therethrough and a stepped section of the stepped bolt inserted through the panel mounting hole is formed such that a portion of the gap in a circumferential direction of the stepped bolt is greater than another portion of the gap in an inserted direction of the stepped bolt.

### Advantageous Effects of Invention

In the mounting structure of the present invention, the mounted-to-panel sections that are to be mounted to the door panel and the mounted-to-lining sections that are to be mounted to the door panel are formed on the peripheral edge of the base member. To mount the vehicle door handle device, first of all, the mounted-to-panel sections are mounted to the door panel. Then, the lining is mounted with the vehicle door handle device kept in a fixed state. Thus, there is no need to keep holding the vehicle door handle device, so that the lining can be mounted with ease.

Further, because the mounted-to-panel sections are each movable within a predetermined range relative to the door panel, it is possible to finely adjust a position of the vehicle door handle device during the mounting work, thereby achieving an improved workability.

Further, because the resilient clips normally bias the base member toward the lining and are attached to the mounted-to-lining sections in such a manner as to pull the base member, it is possible to secure a sufficient mounting accuracy of the lining relative to the base member.

In addition, because the mounted-to-panel sections and the mounted-to-lining sections are formed on the peripheral edge of the base member, they can be covered with the lining, with the result that the outer appearance of the vehicle door handle device can be enhanced.

Further, at least one of the mounted-to-panel sections is disposed on a side toward which the handle section is pivotally pulled relative to the pivot shaft. Namely, the mounted-to-panel section is formed at such a position where an imaginary line interconnecting the distal end of the handle section and the mounted-to-panel section intersects the axis line of the pivot shaft. Thus, the pivoting direction of the handle section and a direction in which the mounted-to-panel section is pressed against the door panel can be matched or conformed with each other. By such directional conformity, it is possible to reduce a load acting on the panel mounting hole during the pivoting operation and thus increase the operating life of the vehicle door handle device.

Further, in the mounting structure of the present invention, the imaginary line interconnecting the pair of the mounted-to-panel sections intersects the axis line of the pivot shaft in the front-rear direction of the vehicle body. In addition, the base member is mounted to the door panel at positions forward and rearward of the pivot shaft. In this way, it is possible to prevent unwanted uplift of the base member during a pivoting operation of the handle section.

Further, in the mounting structure of the present invention, the imaginary line interconnecting the pair of the mounted-to-lining sections intersects the axis line of the pivot shaft in the front-rear direction of the vehicle body. The base member is mounted to the lining at positions forward and rearward of the pivot shaft. Namely, the base member is biased toward the lining at positions forward and rearward of the pivot shaft. Thus, even when the handle section is being pivoted, the base member can be held in close contact with the lining. Further, because the base member is mounted to the lining by means of the two mounted-to-lining sections, it is possible to enhance accuracy of the mounted position of the base member.

Furthermore, in the mounting structure of the present invention, one of the pair of the mounted-to-lining sections is mounted to the lining by means of one of the clips that is vertically resiliently deformable, and the other of the pair of the mounted-to-lining sections is mounted to the lining by means of another of the clips that is horizontally resiliently deformable. With the clips oriented in different directions as above, it is possible to prevent displacement of the lining due to external force, such as vibrating force. Namely, when vertical external force acting in the vertical or up-down direction has been applied to the lining, undesired displacement of the lining is prevented by the vertically-deformable clip. When horizontal external force acting in the front-rear direction has been applied to the lining, undesired displacement of the lining is prevented by the horizontally-deformable clip.

Furthermore, in the mounting structure of the present invention, the gap between the panel mounting hole formed in the mounted-to-panel section and having the stepped bolt inserted therethrough and the stepped section of the stepped bolt inserted through the panel mounting hole is formed such that a portion of the gap in the circumferential direction of the stepped bolt is greater than another portion of the gap in the inserted direction of the stepped bolt. Thus, adjusting margins in the up-down and front-rear directions can be set large, with the result that assembly of the vehicle door handle can be significantly facilitated.

### BRIEF DESCRIPTION OF DRAWINGS

FIG. 1 is a front view of a vehicle door provided with an embodiment of a vehicle door handle device of the present invention;

FIG. 2 is a perspective view of the vehicle door handle device shown in FIG. 1;

FIG. 3 is a perspective view of the vehicle door handle device shown in FIG. 1;

FIG. 4 is a sectional view taken along line 4-4 of FIG. 3;

FIG. 5 is a sectional view taken along line 5-5 of FIG. 3;

FIG. 6 is a view explanatory of dimensions of a stepped bolt and a mounted-to-panel section shown in FIG. 5;

FIG. 7 is a sectional view taken along line 7-7 of FIG. 3;

FIG. 8 is a view explanatory of operation of a clip shown in FIG. 7;

FIG. 9 is a view explanatory of steps for mounting the vehicle door handle device shown in FIG. 3 to a door panel; and

FIG. 10 is a view explanatory of a step of mounting a lining shown in FIG. 1 to the vehicle door handle device.

### DESCRIPTION OF EMBODIMENTS

Now, a description will be given about a vehicle door handle device of the present invention in relation to a case where the vehicle door handle device is mounted on a right front vehicle door.

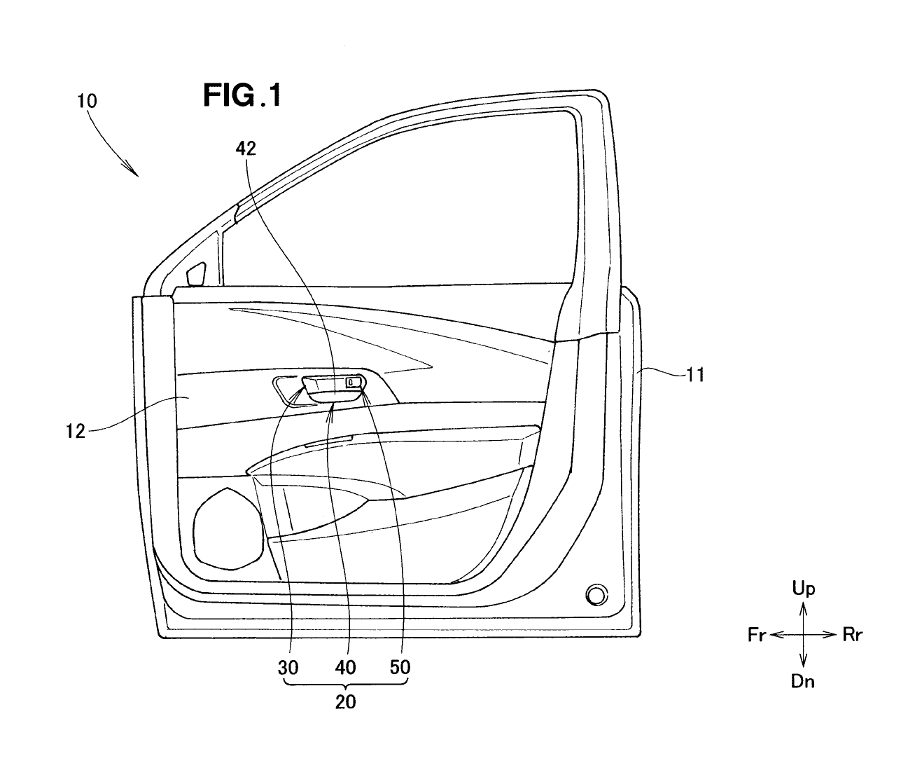

FIG. 1 shows the vehicle door 10 as viewed from inside a passenger compartment. In the vehicle door 10, as shown in FIG. 1, a door panel 11 has an inner (passenger-compartment-side) surface (i.e., surface closer to a reader of the figure) covered with a lining 12, and the vehicle door handle device 20 is supported by the door panel 11 and the lining 12.

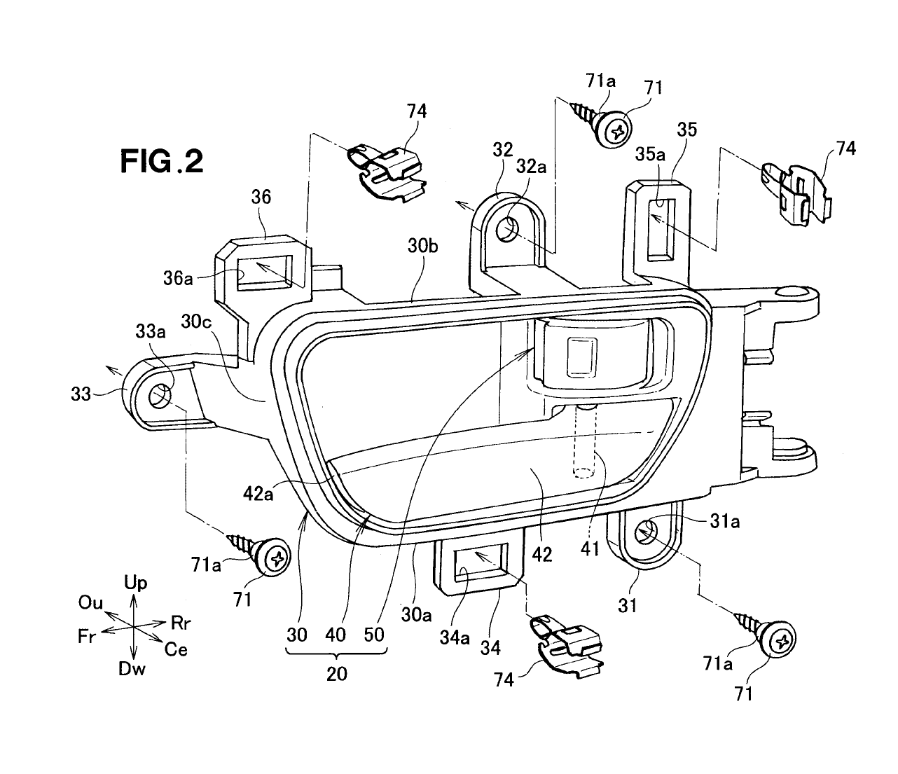

The vehicle door handle device 20 is constructed to be operable to not only switch between locked and unlocked states of the vehicle door 10 but also open and close the vehicle door 10. Details of the vehicle door handle device 20 will be discussed below with reference to FIG. 2 and subsequent figures.

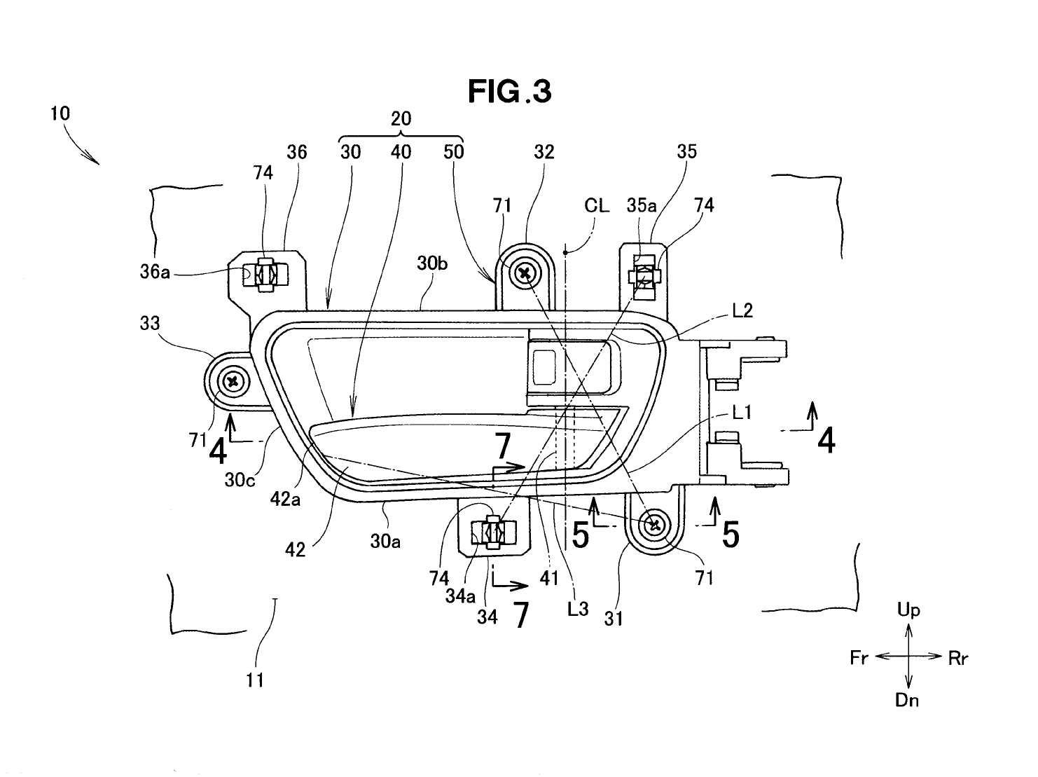

As shown in FIGS. 2 and 3, the vehicle door handle device 20 includes: a base member 30 shaped like a substantially rectangular case as viewed in front elevation; an operating handle 40 pivotably mounted to the base member 30 and operable to open and close the vehicle door 10; and a lock knob 50 pivotably mounted above the operating handle 40 and operable to switch between the locked and unlocked states of the vehicle door 10. The base member 30 is a resin product formed by injection molding.

The base member 30 has three mounted-to-panel sections 31 to 33 and three mounted-to-lining sections 34 to 36 formed on the peripheral edge thereof. The mounted-to-panel sections 31 to 33 are formed for mounting the vehicle door handle device 20 to the door panel 11. The mounted-to-lining sections 34 to 36 are formed for mounting the vehicle door handle device 20 to the lining (depicted aby reference numeral 12 in FIG. 1).

Of the three mounted-to-panel sections 31 to 33, the one formed on the lower edge 30a of the base member 30 and rearward of the axis line CL of a pivot shaft 41 will be referred to as “first mounted-to-panel section 31” as necessary, the one formed on the upper edge 30b of the base member 30 and forward of the axis line CL of the pivot shaft 41 will be referred to as “second mounted-to-panel section 32” as necessary, and the one formed on the front edge 30c of the base member 30 will be referred to as “third mounted-to-panel section 33” as necessary.

An imaginary line L1 interconnecting the first mounted-to-panel section 31 and the second mounted-to-panel section 32 intersects the axis line CL of the pivot shaft 41 in a front-rear direction of a vehicle body. Further, a distance from the first mounted-to-panel section 31 to the axis line CL of the pivot shaft 41a is greater than a distance from the second mounted-to-panel section 32 to the axis line CL of the pivot shaft 41. It is preferable that the distance from the first mounted-to-panel section 31, formed rearward of the axis line CL of the pivot shaft 41, be longer than the distance from the second mounted-to-panel section 32, formed forward of the axis line CL of the pivot shaft 41, to the axis line CL of the pivot shaft 41.

Further, the mounted-to-panel sections 31 to 33 have respective circular panel mounting holes 31a to 33a formed therein for passage therethrough of stepped bolts 71. The vehicle door handle device 20 is mounted to the door panel by means of the stepped bolts 71.

Further, of the three mounted-to-lining sections 34 to 36, the one formed on the lower edge 30a of the base member 30 and forward of the axis line CL of the pivot shaft 41 will be referred to as “first mounted-to-lining section 34” as necessary, the one formed on the upper edge 30b of the base member 30 and rearward of the axis line CL of the pivot shaft 41 will be referred to as “second mounted-to-lining section 35” as necessary, and the one formed on the front edge 30c and the upper edge 30b of the base member 30 will be referred to as “third mounted-to-lining section 36” as necessary.

An imaginary line L2 interconnecting the first mounted-to-lining section 34 and the second mounted-to-lining section 35 slants in an opposite oblique front-rear direction from the above-mentioned imaginary line L1 interconnecting the first panel mounting hole 31 and the second mounted-to-panel section 32. Further, the imaginary line L2 interconnecting the first mounted-to-lining section 34 and the second mounted-to-lining section 35 not only intersects the axis line CL of the pivot shaft 41 in the front-rear direction of the vehicle body, but also intersects the imaginary line L1 interconnecting the first panel mounting hole 31 and the second mounted-to-panel section 32.

Further, the mounted-to-lining sections 34 to 36 have respective rectangular lining mounting holes 34a to 36a for fitting therein clips 74. The clips 74 are attached integrally to the lining, and the vehicle door handle device 20 is mounted to the lining as well by means of the clips 74. Namely, the vehicle door handle device 20 is supported by both of the door panel 11 and the lining.

The first and third lining mounting holes 34a and 36a formed in the first and third mounted-to-lining section 34 and 36 are holes elongated in the front-rear direction. The second lining mounting hole 35a formed in the second mounted-to-lining section 35 is a hole elongated in an up-down direction.

The clips 74 of a same type are used for the first to third lining mounting holes 34a to 36a. These clips 74 differ in their attached direction depending on directions in which the lining mounting holes 34a to 36a are formed.

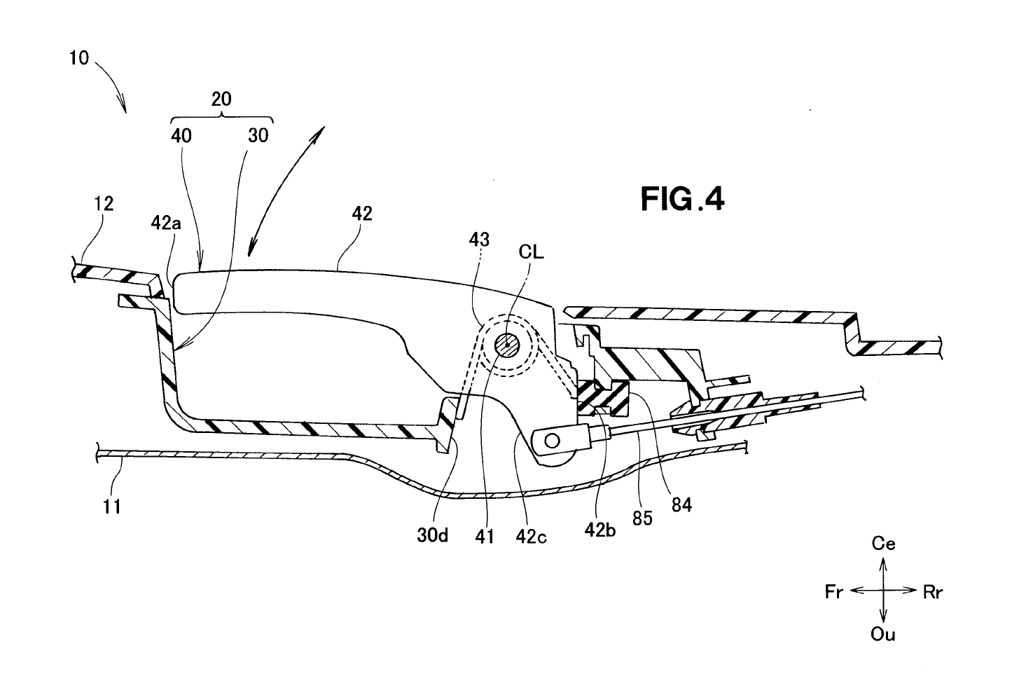

The formed positions of the first and second mounted-to-panel sections 31 and 32 and the first and second mounted-to-lining sections 34 and 35 may be modified as necessary; for example, the positions of the formed positions of the first and second mounted-to-panel sections 31 and 32 and the first and second mounted-to-lining sections 34 and 35 may be reversed in the up-down direction. Namely, the formed positions of the first and second mounted-to-panel sections 31 and 32 and the first and second mounted-to-lining sections 34 and 35 are not limited to those in the illustrated example. The operating handle 40 will be described below in detail later with reference to FIG. 4.

In the operating handle 40, as shown in FIG. 4, the pivot shaft 41, extending vertically (in the up-down direction), is mounted to the base member 30, and a handle section 42 to be gripped and operated by a passenger or vehicle occupant is mounted on the pivot shaft 41.

The pivot shaft 41 is surrounded at its outer periphery with a spring 43 so that the distal end 42a of the handle section 42 is normally biased toward the base member 30.

A rubber stopper 84 is mounted to the base member 30. When the handle section 42 is not being operated, a stopper-abutting surface 42b of the handle section 42 is kept in abutment against the stopper 84 by the biasing force of the spring 43.

To open the vehicle door 10, the vehicle occupant pivots the handle section 42 toward the rear of the vehicle body against the biasing force of the spring 43. In response to the vehicle occupant pivoting the handle section 42 toward the rear of the vehicle body, a wire 85 is pulled so that the vehicle door 10 can be opened. A pivoting amount of the handle section 42 is limited by a pivot limiting section 30d formed on the base member 30. Namely, the pivoting movement of the handle section 42 is limited by a limiting-section abutting surface 42c of the handle section 42 abutting against the pivot limiting section 30d.

With combined reference to FIGS. 3 and 4, the following can be said. At least one of the mounted-to-panel sections (e.g., the first mounted-to-panel section 31) is provided rearward (as viewed in the direction where the handle section 42 is pivotally pulled) of the axis line CL of the pivot shaft 41, i.e. provided on a side toward which the handle section 42 is pivotally pulled relative to the pivot shaft 41 to open the vehicle door.

The first mounted-to-panel section 31 is formed near a position where an imaginary line L3 interconnecting the distal end 42a of the handle section 42 and the first mounted-to-panel section 31 intersects the axis line CL of the pivot shaft 41. Thus, the pivoting direction of the handle section 42 and a direction in which the first mounted-to-panel section 31 is pressed against the door panel 11 can be matched or conformed with each other. By such directional conformity, it is possible to reduce a load acting on the first panel mounting hole 31 during the pivoting operation and thus increase the operating life of the vehicle door handle device 20.

In addition, the base member 30 is mounted to the door panel 11 at positions forward and rearward of the pivot shaft 41. In this way, it is possible to prevent unwanted uplift of the base member 30 during the pivoting operation of the handle section 42.

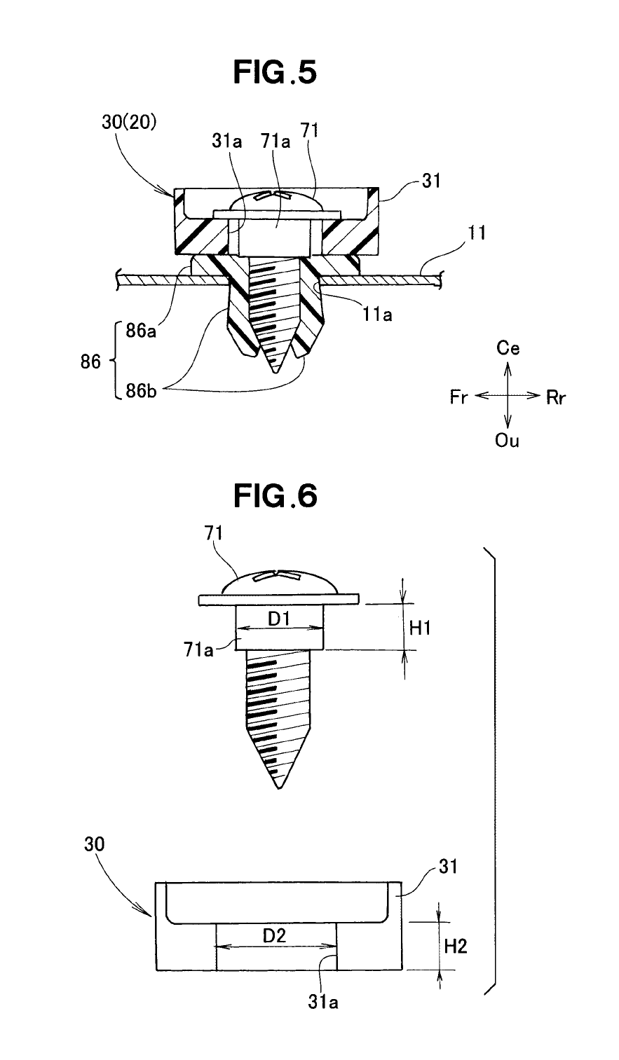

Further, by the base member 30 being mounted to the lining (12 in FIG. 1) by means of two of the mounted-to-lining sections (first and second mounted-to-lining sections 34 and 35), accuracy of the mounted position of the base member 30 can be enhanced. Details of the mounted-to-panel sections (depicted at 31 to 33 in FIG. 2) will be discussed below with reference to FIGS. 5 and 6.

FIG. 5 shows the first mounted-to-panel section 31 duly mounted to the door panel 11. A mounting structure of the second and third mounted-to-panel sections (depicted at 32 and 33 in FIG. 2) is similar to that of the first panel mounting hole 31 and thus will not be described here to avoid unnecessary duplication.

A bolt-attaching clip 86 is fitted through a panel hole 11a formed through the door panel 11. The bolt-attaching clip 86 includes a base section 86a abutted against the door panel 11, and two leg sections 86b extending from the base section 86a in a gradually spreading-out configuration. The bolt-attaching clip 86 is a component part that can be fitted in the door panel 11 by being pushed through the panel hole 11a while the two leg sections 86a are being resiliently deformed toward each other.

To mount the first mounted-to-panel section 31 to the door panel 11, the stepped bolt 71 is screwed into the leg sections 86b with the first panel mounting hole 31a positioned between the leg sections 86b. The leg sections 86b spread out away from each other by the stepped bolt 71 being screwed and thus can be prevented from slipping off the door panel 11. In this manner, the vehicle door handle device 20 can be mounted to the door panel 11.

Further, as shown in FIG. 6, the first panel mounting hole 31a has an inner diameter D2 greater than an outer diameter D1 of a stepped section 71a of the stepped bolt 71. The first panel mounting hole 31a can be moved relative to the stepped bolt 7, fixed to the door panel 11, by an amount corresponding to a difference between the outer diameter D1 of the stepped section of 71a and the inner diameter D2 of the first panel mounting holes 31a. Namely, the first mounted-to-panel section 31 is constructed to be movable within a predetermined range relative to the door panel 11 in the up-down and front-rear directions of the vehicle body.

With the first mounted-to-panel section 31 constructed to be movable relative to the door panel 11 as above, it is possible to finely adjust the mounted position of the vehicle door handle device 20 during mounting work of the vehicle door handle device 20.

Further, the first mounted-to-panel section 31a has a height H2 slightly smaller than a height H1 of the stepped section of 71a of the stepped bolt 71 (e.g., smaller than the height by 0.1 mm). Thus, the first mounted-to-panel section 31 is constructed to be movable in a vehicle with direction as well. In this manner, the first mounted-to-panel section 31 can be moved in all directions.

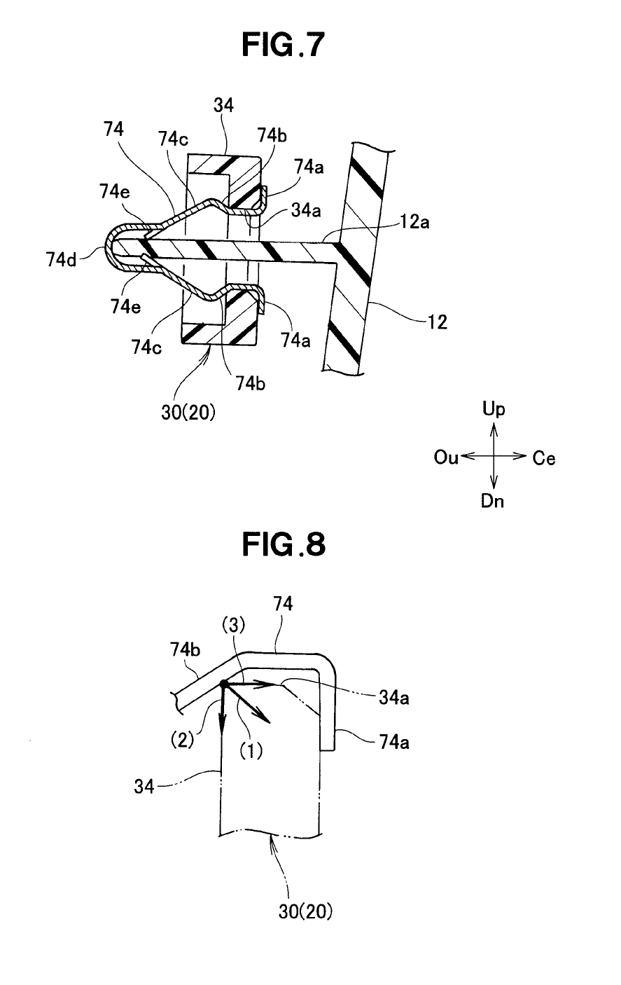

A gap between the first panel mounting hole 31a and the stepped section 71a of the stepped bolt 71 inserted through the mounting hole 31a is formed such that a portion of the gap in a circumferential direction of the stepped bolt is greater than another portion of the gap in an inserted direction of the stepped bolt; namely, (D2−D1)>(H1−H2). Adjusting margins in the up-down and front-rear directions can be set large like this, so that assembly of the vehicle door handle 20 can be facilitated. Details of the limiting mounting sections (indicted by reference numerals 34 to 36 in FIG. 2) will be discussed later with reference to FIGS. 7 and 8.

FIG. 7 shows the clip 74 attached to the first lining mounting hole 34a. A mounting structure of the third lining mounting hole (indicated by reference numeral 36 in FIG. 2) is similar to that of the lining mounting hole 34a. Further, the second lining mounting hole (indicated by reference numeral 35a in FIG. 2) is the same in basic construction as that of the lining mounting hole 34a, except that a mounting direction of the second lining mounting hole 35a is different by 90° from that of the lining mounting hole 34a. Therefore, a detailed description about the second and third lining holes 35a and 36a will be omitted here to avoid unnecessary duplication.

A clip mounting section 12a for mounting thereon the clip 74 is formed on the lining 12. The clip 74 includes: base sections 74a fitted in the first lining mounting hole 34a; first taper sections 74b extending from the base sections 74a in a gradually spreading-out fashion; second taper sections 74c extending from the respective distal ends of the first taper sections 74b toward each other in a gradually tapering (narrowing) fashion; a head section 74d having a generally U sectional shape to interconnect the second taper sections 74c and cover a distal end portion of the clip mounting section 12a; and claw sections 74e extending from the second taper sections 74c into biting engagement with the clip mounting section 12a.

The clip 74 is attached in a resiliently deformed state so as to expand the first lining mounting hole 34a in the up-down direction. Namely, the clip 74 attached to the first lining mounting hole 34a is in a state resiliently deformed vertically in the up-down direction.

As seen in FIG. 2, the second lining mounting hole 35a is a rectangular hole elongated in the up-down direction. The clip 74 fitted in the second lining mounting hole 35a is attached in a resiliently deformed state so as to expand the second lining mounting hole 35a in the front-rear direction. Namely, the clip 74 attached to the second lining mounting hole 35a is in a state resiliently deformed horizontally or in the front-rear direction.

The foregoing description can be summarized as follows. One of a pair of upper and lower mounted-to-lining sections 34 and 35, i.e. the first mounted-to-lining section 34, is attached to the lining 12 via the vertically-deformable clip 74, and the other of the pair, i.e. the second mounted-to-lining section 35, is attached to the lining 12 via the horizontally-deformable clip 74. With the clips 74 oriented in different directions as above, it is possible to prevent undesired displacement of the lining 12 due to external force, such as vibrating force. Namely, when vertical external force acting in the up-down direction has been applied to the lining 12, undesired displacement of the lining 12 is prevented by the vertically-deformable clip 74. When horizontal external force acting in the front-rear direction has been applied to the lining 12, displacement of the lining 12 is prevented by the horizontally-deformable clip 74.

As shown in FIG. 8, the first taper sections 74b of the clip 74 are each held in contact with the edge of the first lining mounting hole 34a in tilted relation to the latter. Thus, resilient force of the clip 74 transmits to the first lining mounting hole 34a via the first taper sections 74b as indicated by arrow (1).

A portion of the resilient force of the clip 74 acts in such a direction as to expand the first lining mounting hole 34a, as indicated by arrow (2). Further, the remaining portion of the resilient force of the clip 74 acts in such a direction as to bias the base member 30 toward a widthwise center of the vehicle, as indicated by arrow (3).

As also shown in FIG. 7, the lining 12 is disposed on a side of the base member 30 closer to the widthwise center of the vehicle. Namely, the base member 30 is normally biased toward the lining 12 by means of the clip 74.

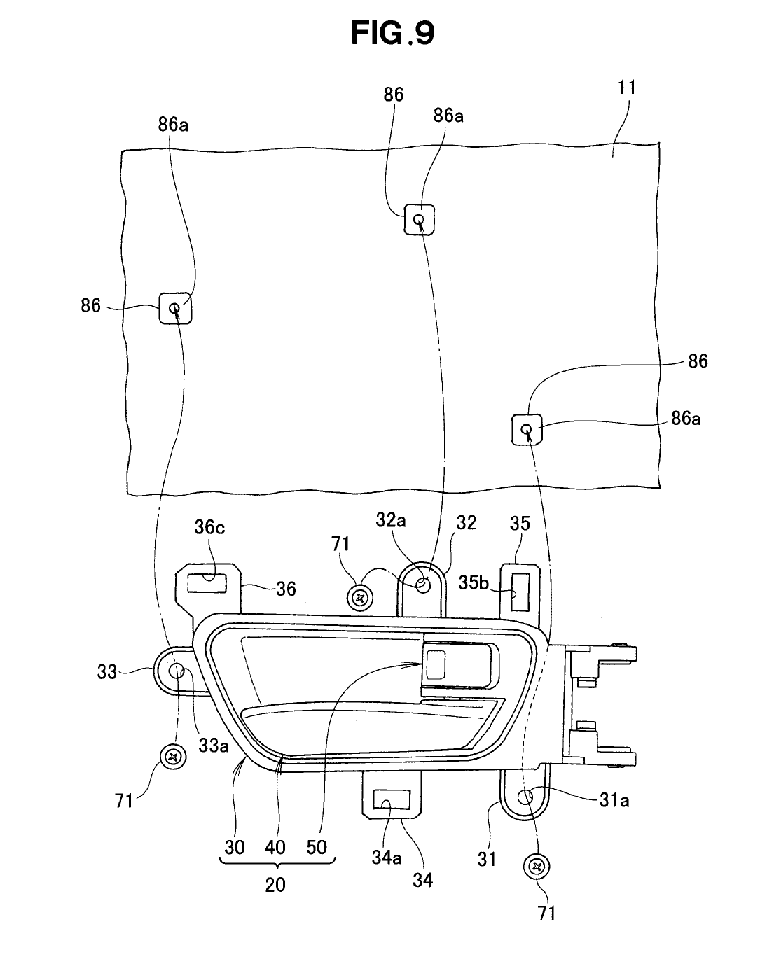

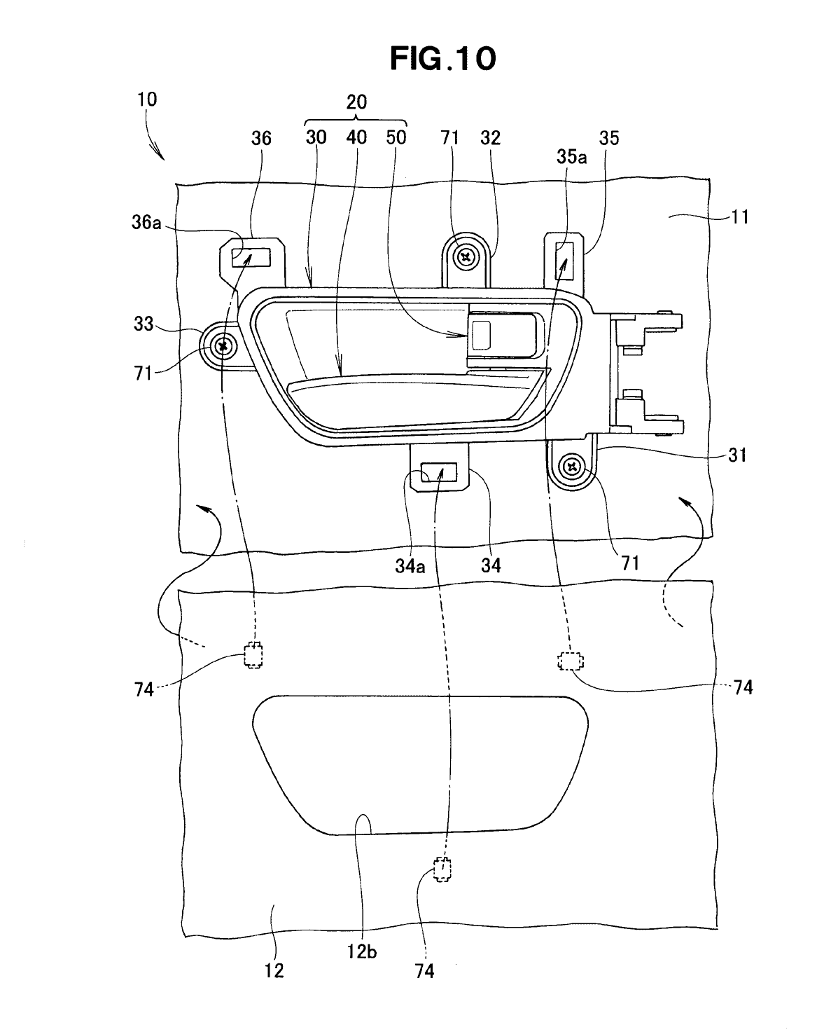

As shown in FIGS. 3 and 7, the imaginary line L1 interconnecting the pair of mounted-to-panel sections (the first and second mounted-to-panel sections 31 and 32 intersects the axis line CL of the pivot shaft 41 in the front-rear direction of the vehicle body. The base member 30 is mounted to the lining 12 at positions forward and rearward of the axis line CL of the pivot shaft 41. Thus, even when the handle section 42 is being pivoted, the base member 30 can be held in close contact with the lining 12. Details of how the vehicle door handle device 20 is assembled will be discussed below with reference to FIGS. 9 and 10.

As shown in FIG. 9, first, the vehicle door handle device 20 is mounted to the door panel 11. More specifically, the first to third mounted-to-panel sections 31 to 33 are fastened by means of the stepped bolts 71 to the bolt mounting clips 74 fixed to the door panel 11. Steps of assembling the vehicle door handle device 20 will be described with reference to FIG. 10.

As shown in FIG. 10, the lining 12 is mounted to the vehicle door handle device 20 already mounted to the door panel 11. The clips 74 attached to the lining 12 are positioned in alignment with the first to third mounted-to-lining sections 34 to 36, and then the lining 12 is pressed against the vehicle door handle device 20 so that the clips 74 are fitted in the first to third mounted-to-lining sections 34 to 36. In this manner, work for mounting the vehicle door handle device 20 is completed.

To mount the vehicle door handle device 20, first of all, the first to third mounted-to-lining sections 34 to 36 are mounted to the door panel 11. Then, the lining 12 is mounted to the vehicle door handle device 20 kept in a fixed stated. Thus, there is no need to keep holding the vehicle door handle device 20, so that the lining 12 can be mounted to the vehicle door handle device 20 with ease.

In addition, the first to third mounted-to-panel sections 31 to 33 and the first to third mounted-to-lining sections 34 to 36 are formed on the peripheral edge of the base member 30. Thus, the first to third mounted-to-panel sections 31 to 33 and the first to third mounted-to-lining sections 34 to 36 can be covered with the lining 12. Namely, the first to third mounted-to-panel sections 31 to 33, the first to third mounted-to-lining sections 34 to 36 and the mounting component parts (stepped bolts 71 and clips 74) can be covered with the lining 12, and thus, it is possible to enhance the outer appearance of the vehicle door handle device 20. Namely, only the principal section of the base member 30, the operating handle 40 and the lock knob 50 are visible through an opening 12b of the lining 12.

Whereas the vehicle door handle device of the present invention has been described above as applied to the right front vehicle door, it may be applied to a left or rear vehicle door and should not be construed as limited to the aforementioned construction.

### INDUSTRIAL APPLICABILITY

The basic principles of the present invention are well suited for application to doors of passenger vehicles.

### REFERENCE SIGNS LIST

10 . . . vehicle door, 11 . . . door panel, 12 . . . lining, 20 . . . vehicle door handle device, 30 . . . base member, 31 to 33 . . . mounted-to-panel sections, 31a to 33a . . . panel mounting holes, 34 to 36 . . . mounted-to-lining sections, 41 . . . pivot shaft, 42 . . . handle section, 71 . . . stepped bolt, 71a . . . stepped section, 74 . . . clip, CL . . . axis line, L1 . . . imaginary line interconnecting the mounted-to-panel sections, L2 . . . imaginary line interconnecting the mounted-to-lining sections

1-6. (canceled)

7. A mounting structure for a vehicle door handle device comprising a door panel of the vehicle door, a lining covering an inner side of the door panel facing a passenger compartment, and a vehicle door handle device mounted to both the door panel and the lining and operable to open and close the door,
the vehicle door handle device including a pivot shaft mounted to extend vertically toward upper and lower wall portions of a base member, and a handle section pivotably mounted on the pivot shaft,
the base member including mounted-to-panel sections and mounted-to-lining sections formed on a peripheral edge thereof, the mounted-to-panel sections being mounted to the door panel, the mounted-to-lining sections being mounted to the lining,
the mounted-to-panel sections being each constructed to be movable relative to the door panel, along a surface of the vehicle door, within a predetermined range,
the mounted-to-lining sections being mounted to the lining by means of resilient clips,
the clips normally biasing the base member toward the lining.

8. The mounting structure for a vehicle door handle device according to claim 7, wherein at least one of the mounted-to-panel sections is disposed on a side toward which the handle section is pivotally pulled relative to the pivot shaft.

9. The mounting structure for a vehicle door handle device according to claim 7, wherein the mounted-to-panel sections are provided in a pair on upper and lower portions of the peripheral edge of the base member, and
an imaginary line interconnecting the pair of the mounted-to-panel sections intersects an axis line of the pivot shaft in a front-rear direction of the vehicle body.

10. The mounting structure for a vehicle door handle device according to claim 9, wherein the mounted-to-lining sections are provided in a pair on upper and lower portions of the peripheral edge of the base member,
an imaginary line interconnecting the mounted-to-lining sections not only tilts in an opposite oblique front-rear direction from the imaginary line interconnecting the pair of the mounted-to-panel sections,
the imaginary line interconnecting the mounted-to-panel sections intersects the imaginary line interconnecting the mounted-to-lining sections.

11. The mounting structure for a vehicle door handle device according to claim 10, wherein one of the pair of the mounted-to-lining sections is mounted to the lining by means of one of the clips that is vertically resiliently deformable, and other of the pair of the mounted-to-lining sections is mounted to the lining by means of another of the clips that is horizontally resiliently deformable.

12. The mounting structure for a vehicle door handle device according to claim 7, wherein each of the mounted-to-panel sections is mounted to the door panel by means of a stepped bolt, and
a gap between a panel mounting hole formed in the mounted-to-panel section and having the stepped bolt inserted therethrough and a stepped section of the stepped bolt inserted through the panel mounting hole is formed such that a portion of the gap in a circumferential direction of the stepped bolt is greater than another portion of the gap in an inserted direction of the stepped bolt.

13. The mounting structure for a vehicle door handle device according to claim 8, wherein each of the mounted-to-panel sections is mounted to the door panel by means of a stepped bolt, and
a gap between a panel mounting hole formed in the mounted-to-panel section and having the stepped bolt inserted therethrough and a stepped section of the stepped bolt inserted through the panel mounting hole is formed such that a portion of the gap in a circumferential direction of the stepped bolt is greater than another portion of the gap in an inserted direction of the stepped bolt.

14. The mounting structure for a vehicle door handle device according to claim 9, wherein each of the mounted-to-panel sections is mounted to the door panel by means of a stepped bolt, and
a gap between a panel mounting hole formed in the mounted-to-panel section and having the stepped bolt inserted therethrough and a stepped section of the stepped bolt inserted through the panel mounting hole is formed such that a portion of the gap in a circumferential direction of the stepped bolt is greater than another portion of the gap in an inserted direction of the stepped bolt.

15. The mounting structure for a vehicle door handle device according to claim 10, wherein each of the mounted-to-panel sections is mounted to the door panel by means of a stepped bolt, and
a gap between a panel mounting hole formed in the mounted-to-panel section and having the stepped bolt inserted therethrough and a stepped section of the stepped bolt inserted through the panel mounting hole is formed such that a portion of the gap in a circumferential direction of the stepped bolt is greater than another portion of the gap in an inserted direction of the stepped bolt.

16. The mounting structure for a vehicle door handle device according to claim 11, wherein each of the mounted-to-panel sections is mounted to the door panel by means of a stepped bolt, and
a gap between a panel mounting hole formed in the mounted-to-panel section and having the stepped bolt inserted therethrough and a stepped section of the stepped bolt inserted through the panel mounting hole is formed such that a portion of the gap in a circumferential direction of the stepped bolt is greater than another portion of the gap in an inserted direction of the stepped bolt.
